(19) United States
(12) Patent Application Publication
(10) Pub. No.: US 2002/0108293 A1
(43) Pub. Date: Aug. 15, 2002

(54) Dough bait retention fishing lure

(76) Inventor: John A. Bambacigno, Grangeville, ID (US)

Correspondence Address: WELLS ST. JOHN P.S., 601 W. FIRST, SUITE 1300, SPOKANE, WA, 99201-3828, US

(21) Appl. No.: 10/116,658

(22) Filed: Apr. 3, 2002

Related U.S. Application Data
(62) Division of application No. 09/610,161, filed on Jul. 5, 2000.

(51) Int. Cl. A01K 85/00

(52) U.S. Cl. 43/42.19

(57) ABSTRACT

A dough bait retention fishing lure is described, in which a dough bait receptacle is provided with an outer surface. The dough bait receptacle defines at least one outwardly open dough bait retention opening along the outer surface. The dough bait retention opening changes in size inwardly from the outer surface.

### TECHNICAL FIELD

The present invention relates generally to fishing lures, and more particularly to retention of dough type fishing bait in a fishing lure.

### BACKGROUND OF THE INVENTION

Dough type baits are very popular substitutes for live or synthetic baits. Instead of requiring the fisherman to attempt placing a live organism on a fishing hook, dough bait can be molded about the hook. This is a convenience for several reasons. Dough bait can be made to last or remain effective over long periods of time, thereby eliminating waste of live bait which has a very finite useful life. Dough bait can also be provided with many different scents that have been shown to be effective fish attractants.

Dough bait likely evolved from the use of bread dough as a fish bait. Freshly baked bread would be used, especially the soft inner core of the loaf. A pinch of the soft bread would be kneaded into a ball and attached to a fish hook. Enterprising fishing bait producers have taken the bread dough bait several steps further and have produced a longer lasting and more easily formed material that has become a very popular alternative to live bait.

Even though popular, especially with novice fishermen, dough bait is not without problems. Dough bait dissolves in water. Thus, the fisherman must periodically check his or her hook to determine if fresh bait needs to be applied. Also, too much or too little bait may be applied to a hook. If too much bait is applied, a fish may bite and escape because there is no chance for the hook to set through the dough bait material. If too little dough bait is applied, the hook may be visible and no fish will bite, or the small amount of dough will quickly dissolve and leave a bare hook. Also, it is a fair likelihood that the bait will partially dissolve and drop from the hook, either in water or in the air during casting.

There is a need therefore for a retainer that will physically hold dough bait in place and that will not allow the bait to quickly dissolve.

The present invention therefore has, for a first object, to provide a dough bait retainer that will accept a dough bait and physically hold the bait for slow and substantially complete dissolution in water.

Another object is to provide such a retainer that may be provided in numerous forms for different fishing applications.

A still further object is to provide such a retainer that is easy to use with numerous types of dough baits.

The above and further objects and advantages may become apparent from the following description.

### BRIEF DESCRIPTION OF THE DRAWINGS

Preferred embodiments of the invention are described below with reference to the following accompanying drawings.

FIG. 1 is a perspective view of a first preferred exemplary form of the present dough bait retention fishing lure;

FIG. 2 is a perspective view of a second preferred exemplary form of the present lure with a spinner;

FIG. 3 is a perspective view or a further preferred exemplary form of the present lure with a flexible synthetic bait;

FIG. 4 is a still further preferred exemplary form of the present lure with a synthetic fly bait;

FIG. 5 is an enlarged sectional view taken transversely through a preferred dough bait receptacle;

FIG. 6 is an enlarged fragmentary view showing a longitudinal section or the preferred dough bait receptacle; and

FIG. 7 is a perspective view of an exemplary form of the lure in the form of a fishing plug.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

It is noted that the present invention is intended primarily as a retainer for dough bait. Dough bait is commonly used by sport fishermen as a bait substitute for live or other organic bait such as worms, grubs, salmon eggs, etc. Dough bait is a paste that is typically provided in a thick, pliable consistency that can be molded and formed around a fish hook. Dough bait may include any of several or a combination of known fish attracting compounds. One popular and widely commercial available dough bait is produced by Berkley, with offices at 1900 18th Street, Spirit Lake, Iowa 51360, and is distributed under the trademark “Power Bait”.

It is pointed out that the present invention may also be used with other paste-type baits or attractants and that such bait or attractants are included within the meaning of the term “dough bait” in this application.

Before describing specific preferred elements of the invention and their particular preferred relationships, general aspects will first be discussed.

In a first general aspect, a preferred form of the invention includes a dough bait retention fishing lure 10. The lure 10 includes a dough bait receptacle 12 including an outer surface 14. The dough bait receptacle 12 defines at least one outwardly open dough bait retention opening 16 along the outer surface 14. The dough bait retention opening 15 changes in size inwardly from the outer surface 14.

In another general aspect, the dough bait retention fishing lure 10 includes a fish hook 18. The dough bait receptacle 12 is connected to the hook 18 and includes a plurality of outwardly open dough bait retention openings 16 between forward and rearward dough bait receptacle ends 20, 22 respectively. The dough bait receptacle is formed along an axis X and the dough bait retention openings reduce in size inwardly toward the axis.

In a still further general aspect, the dough bait retention fishing lure 10 includes the fish hook 18 and a shaft 24 connected to the fish hook. The shaft 24 leads from the fish hook 18 to a forward shaft end 26. A fish-attracting lure element 28 is also connected to the hook 18. The dough bait receptacle 12 is mounted to the shaft forward of the fish hook and includes a plurality of the outwardly open dough bait retention openings 16. Stops 30 are mounted on the shaft at opposed ends of the dough bait receptacle. A fish line connector 32 is also provided on the shaft 24.

More specific discussion will now be made with regard to preferred, exemplary features of the invention.

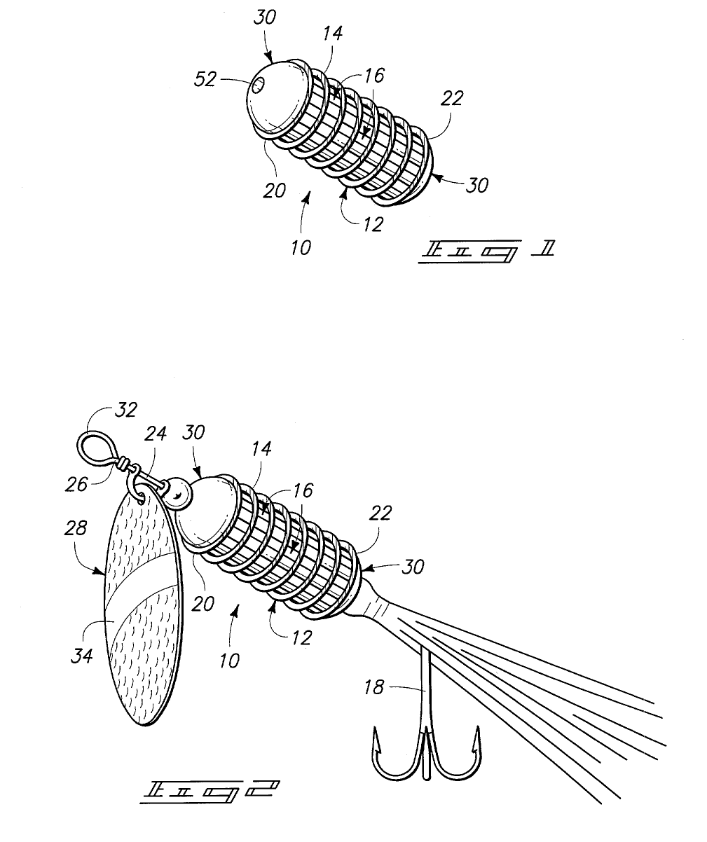

Referring now to FIGS. 1-4, preferred examples of lures 10 are shown embodying features of the invention. In FIG. 1, the present lure is shown without additional fish-attracting elements. The lure 10 may be used in this form for retaining a dough bait for slow dispensation when immersed in water.

In fact, the outer surface 14 may take numerous forms, such as a slider type lure body (FIG. 1). As such, the lure may be slidably attached to a fish line ahead of any fishing bait or lure to attract fish by scent (when charged with dough bait), and if appropriate visual indicia is applied to the outer surface 14, visual attraction may also be employed. The lure may be made as a plug with an attached hook (shown in dashed lines in FIG. 1), or in a shape to be used in conjunction with an existing form of plug or lure.

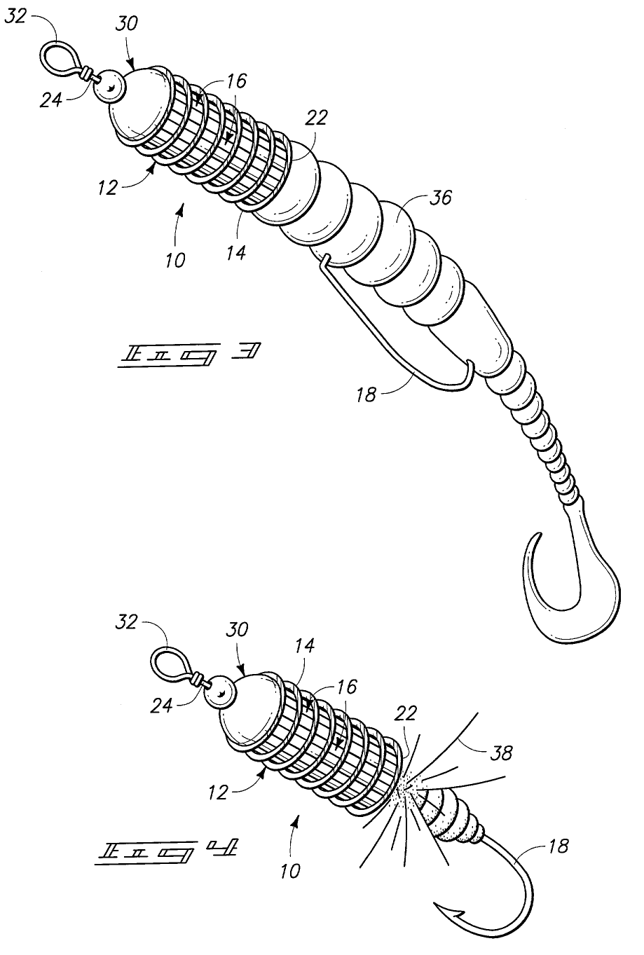

It is noted that the lure may include a substantially circular cross-sectional configuration as shown in FIGS. 1-4, and be slidably positioned or otherwise attached along a fish line. The lure 10 may be separate from an existing lure as shown in FIG. 1, or include other lure elements as shown in FIGS. 2-4 and 7. The present lure 10 may be produced in a round, rectilinear, or other shape that may be complimentary to a conventional lure or plug to minimize interference with the action and appearance of the selected conventional lure or plug.

In FIG. 2, the lure 10 is provided with the lure element 28 in the form of a spoon type spinner 34 attached to the shaft 24 forward of the receptacle 12. The rotating action of the spinner 34 may serve to visually attract fish in the usual manner, and also have an effect on water passage over the following receptacle, by creating a swirl in which the fish scent carried in the slowly dissolving dough bait will be dissipated behind the lure.

In FIG. 3, the fish-attracting lure element 28 is a flexible simulated bait 36 that is connected to the hook 18. The exemplified bait 36 is illustrated as a simulated worm. It should be understood, however, that many other forms of flexible bait may be used as well. The receptacle 12 is mounted forwardly of the bait 38 and may be slidably connected to a fish line leading to the bait.

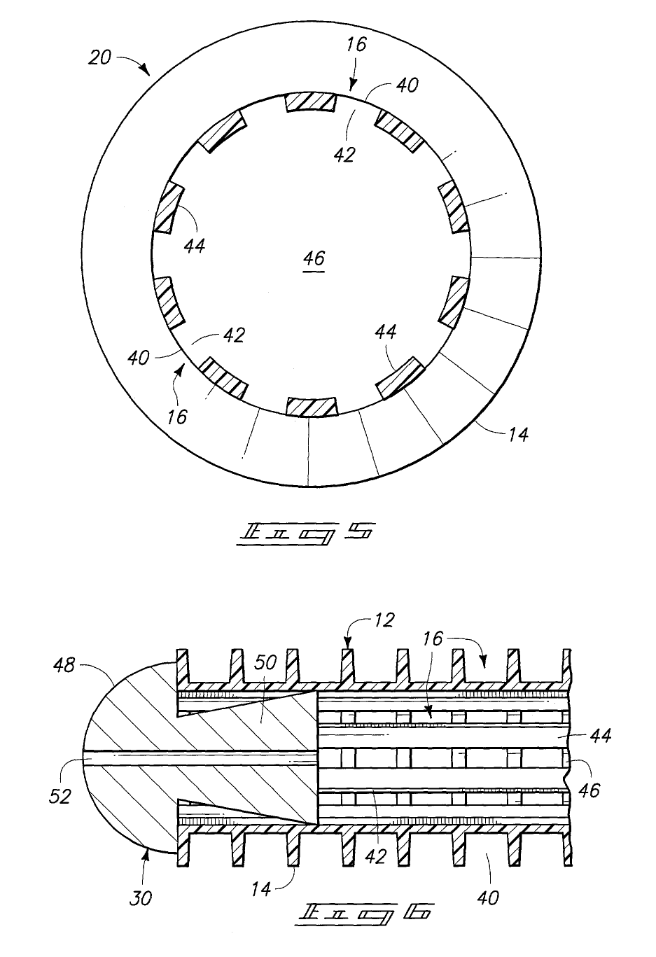

In FIG. 4, the lure element 28 is in the form of a fishing fly 38. Again, various color, size and shaped flies may be used, and if desired, in combination with other elements. For example, a fly 38 may be used behind a spinner 34, with the receptacle 12 situated between the two.

In FIG. 7, the lure element 28 is shaped as a fishing plug, with the dough bait receptacle 12 integrated in the plug body. As shown, more than one hook 18 may be used, along with other elements that may be used to influence a desired action of the lure in the water. The example illustrated is indicative of the ability for the present lure to be produced in numerous forms. The receptacle 12 may thus be formed in a variety of shapes, be attached to an existing lure body, be used separately, or be used in conjunction with existing conventional lures or bait arrangements.

The examples given above are set forth to indicate an exemplary variety of configurations that the present lure 10 may take. These are merely examples and it should be understood that other configurations and combinations may also be used.

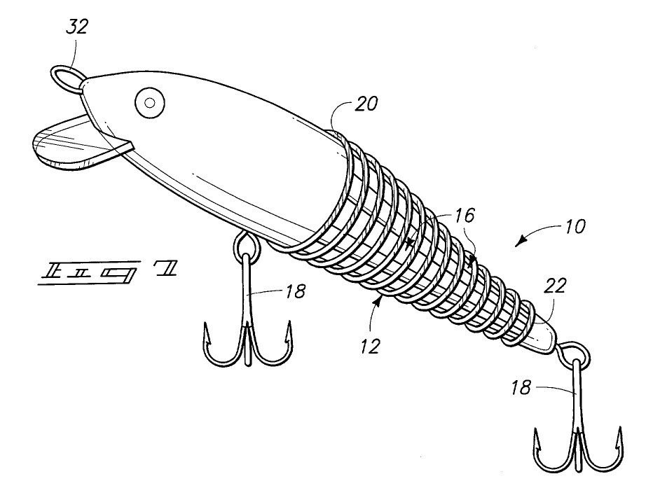

Referring now to FIGS. 5 and 6, reference will be made to particular elements exemplifying the dough bait receptacle 12.

In the illustrated example, the receptacle 12 is tubular and elongated. However, it should be understood that the receptacle could take other forms that are not tubular or circular in cross section.

The receptacle 12 includes or defines at least one and most preferably a plurality of the dough bait retention openings 16 which open at least along the outer surface 14. In preferred forms, the openings change in size inwardly from the outer surface 14. Expressed another way, the openings 16 will taper from an opening size along the outer surface to a different size at a location inward of the outer surface 14. In the example shown in the drawings, the open ends 40 along the outer surface are enlarged. The openings taper from the enlarged ends 40 to smaller or reduced ends 42. In the preferred forms illustrated, the reduced ends 42 are also open.

In the example shown in FIG. 5, the dough bait receptacle is hollow and includes an inner surface 44. The reduced open ends 42 are formed along the inner surface 44 and open into an internal dough bait receiving chamber 46 that is defined by the inner surface 44.

The tapered dough bait retention openings 16 serve to mechanically secure dough bait that has been pressed into the openings 16. The bait will compress somewhat, due to the tapered nature of the openings, and form tightly against the walls of the openings.

The above is especially true of bait that is pressed through the openings and into the chamber 46. The bait will naturally curl as it is extruded through the openings and form into the shape of the chamber. The formed shape will not readily pass back out through the openings and thus will remain in the chamber until water dissolves the bait material. Only substantially dissolved material be allowed to escape the lure 10.

In preferred forms, the dough bait receptacle 12 is tubular with opposed open ends 20, 22. This configuration is preferable to enable manufacture of the receptacle by conventional molding processes. Preferably, the receptacle is formed of plastic by injection molding.

It is desirable to close the ends 20 and 22 so bait will not easily escape the chamber 46. Thus, the stops 30 are provided. FIG. 6 shows an example of a preferred stop 30. The stop configuration illustrated has the advantage of both spanning and securing the otherwise open end of the dough bait receptacle 12. Thus, the preferred stop includes a headed end 48 that is sized to span the chamber 46, and a shank 50 that may be sized to be forcibly yet releasably fitted into the chamber to grip the inner surface 44.

Each stop 30 may also include a shaft or fish line receiving bore 48. The bore 48 is preferably centered in the stop, and so will be in substantial coaxial relation to the receptacle axis X when fitted to the receptacle 12.

Stops 30 may be fitted to opposed ends of the receptacle to close the receptacle ends and to guide the lure on a shaft 24, or along a fish line slidably received through the bores 48. It is preferable that the stops 30 be removably attached to the receptacle 12 so they may be disengaged to facilitate cleaning of the receptacle chamber 46 and to facilitate assembly on a shaft or fish line.

Operation of the invention will now be explained, given that the lure 10 has been mounted to a fish line and is ready to be charged with dough bait.

Dough bait, being typically moldable and of a paste or putty texture, may be pressed by the user's fingers into the various retention openings 16. The bait will deform as it is pressed into the openings 16 and take the shape of the opening side walls. If the receptacle is hollow as described above, at least some of the bait will be extruded through the reduced inner ends 42 of the openings 16 and into the chamber 46.

Enough bait may be pressed into the openings 16 to fill the chamber 46. The bait in the chamber 46 will mold itself into the shape of the chamber and the openings. The bait thus becomes mechanically secured within the chamber and openings unless force is applied from the inside to extrude the bait back outwardly. Nothing is provided within the receptacle to produce such outward force, so the bait will remain secured in place.

In use, water will slowly dissolve the bait, starting with that part of the bait that is exposed along the outer surface of the receptacle at the outward opening ends 40. The bait will slowly dissolve within the openings and enter the surrounding water in the dissolved state, hopefully attracting fish by scent.

As exposure to water continues, dissolution of the bait will also continue until only the bait contained within the chamber 46 remains. The bait remaining in the chamber will have previously been formed into the shape of the chamber and cannot escape through the openings until it dissolves to a size smaller than the internal opening ends 42. Thus, the bait will be held within the lure 10 until it has almost completely dissolved.

Once the bait dissolves, the lure can be re-charged with fresh bait and fishing can continue.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A dough bait retention fishing lure, comprising:
a dough bait receptacle including an outer surface;
wherein the dough bait receptacle defines at least one outwardly open dough bait retention opening along the outer surface; and
wherein the dough bait retention opening changes in size inwardly from the outer surface.

2. A dough bait retention fishing lure as defined by claim 1, wherein the dough bait receptacle includes an internal dough bait receiving chamber and wherein the dough bait retention opening extends from the outer surface into the dough bait receiving chamber.

3. A dough bait retention fishing lure as defined by claim 1, wherein the dough bait receptacle is tubular.

4. A dough bait retention fishing lure as defined by claim 1, wherein the dough bait receptacle is tubular and includes opposed open ends.

5. A dough bait retention fishing lure as defined by claim 1, wherein the dough bait receptacle is tubular and includes opposed open ends; and further comprising stops releasably engaging and spanning the opposed open ends.

6. A dough bait retention fishing lure as defined by claim 1, wherein the dough bait receptacle includes opposed open ends; and further comprising stops releasably engaging and spanning the opposed open ends.

7. A dough bait retention fishing lure, comprising:
a fish hook;
a dough bait receptacle connected to the hook and including a plurality of outwardly open dough bait retention openings between forward and rearward dough bait receptacle ends;
wherein the dough bait receptacle is formed along an axis and wherein the dough bait retention openings are reduced in size inwardly toward the axis.

8. A dough bait retention fishing lure as defined by claim 7, wherein the dough bait receptacle is hollow, with an outward surface and an inward surface and wherein at least some of the open dough bait retention openings include reduced openings along the inward surface and enlarged openings along the outward surface.

9. A dough bait retention fishing lure as defined by claim 7, further comprising a fish attracting lure element connected to the hook.

10. A dough bait retention fishing lure as defined by claim 7, wherein the dough bait receptacle is tubular.

11. A dough bait retention fishing lure as defined by claim 7, wherein the dough bait receptacle is tubular and formed along an axis; and
wherein the hook is attached to a shaft that extends axially through the dough bait receptacle.

12. A dough bait retention fishing lure as defined by claim 7, wherein the dough bait receptacle includes opposed forward and rearward ends, and wherein at least the forward is closed.

13. A dough bait retention fishing lure, comprising:
a fish hook;
a shaft connected to the fish hook and leading from the fish hook to a forward shaft end;
a fish attracting lure element connected to the hook;
a dough bait receptacle mounted to the shaft forward of the fish hook and including a plurality of outwardly open dough bait retention openings;
stops mounted on the shaft at opposed ends of the dough bait receptacle; and
a fish line connector on the shaft.

14. A dough bait retention fishing lure as defined by claim 13, wherein the dough bait receptacle is open on opposed ends.

15. A dough bait retention fishing lure as defined by claim 13, wherein the dough bait receptacle is tubular and includes open opposed ends.

16. A dough bait retention fishing lure as defined by claim 13, wherein the dough bait receptacle is formed as a tube.

17. A dough bait retention fishing lure as defined by claim 13, wherein the dough bait receptacle is formed as a tube with open opposed ends and wherein the stops releasably span the open opposed ends.

18. A dough bait retention fishing lure as defined by claim 13, wherein the dough bait receptacle is open on opposed ends and wherein the stops releasably engage the opposed ends.

19. A dough bait retention fishing lure as defined by claim 13, wherein the shaft is centered within the dough bait receptacle along an axis.

20. A dough bait retention fishing lure as defined by claim 13, wherein the dough bait receptacle includes an inner surface and an outer surface and wherein the outwardly open dough bait retention openings taper from reduced openings along the inner surface to enlarged openings along the outer surface.

21. A dough bait retention fishing lure as defined by claim 13, wherein the dough bait receptacle is slidably mounted on the shaft and wherein the shaft extends longitudinally through the dough bait receptacle.

22. A dough bait retention fishing lure as defined by claim 13, wherein the fish attracting lure element is a spoon type spinner.

23. A dough bait retention fishing lure as defined by claim 13, wherein the fish attracting lure element is a flexible simulated bait.

24. A dough bait retention fishing lure as defined by claim 13, wherein the fish attracting lure element is a plug.

25. A dough bait retention fishing lure as defined by claim 13, wherein the fish attracting lure element is a fly.
